(19) United States
(12) Patent Application Publication
(10) Pub. No.: US 2008/0084371 A1
(43) Pub. Date: Apr. 10, 2008

(54) LIQUID CRYSTAL DISPLAY FOR PREVENTING RESIDUAL IMAGE PHENOMENON AND RELATED METHOD THEREOF

(75) Inventors: Chih-hsiang Yang, Hsin-Chu City (TW); Sheng-kai Hsu, Hsin-Chu City (TW); Chun-fan Chung, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu (TW)

(21) Appl. No.: 11/753,831

(22) Filed: May 25, 2007

(30) Foreign Application Priority Data
Oct. 5, 2006 (TW) 095137219

(51) Int. Cl. G09G 3/36

(52) U.S. Cl. 345/87

(57) ABSTRACT

A liquid crystal display device for preventing residual image includes a liquid crystal panel having a plurality of pixel units for displaying an image, a detecting circuit for generating a power control signal in response to a power switching signal, and a source driver. The source driver includes a processing unit, a plurality of first switch units, and a plurality of second switch units. The processing unit is used for providing a data signal. The plurality of first switch units coupled electrically to the processing unit, are used for conducting the data signal to the plurality of pixel units when the power switching signal is at a first state. The plurality of second switch units are used for electrically connecting the plurality of pixel units when the power switching signal is at a second state.

### BACKGROUND OF THE INVENTION

1. Field of the Invention

The present invention relates to a liquid crystal display and method for preventing residual image phenomenon, and more specifically, to a liquid crystal display capable of preventing residual image phenomenon and a related method by using charge-sharing principle.

2. Description of the Related Art

With a rapid development of monitor types, novel and colorful monitors with high resolution, e.g., liquid crystal displays (LCD devices), are indispensable components used in various electronic products such as monitors for notebook computers, personal digital assistants (PDA), digital cameras, and projectors. The demand for the novelty and colorful monitors has increased tremendously.

Nevertheless, a residual image phenomenon occurs in the moment of shutting down the liquid crystal display, for residual charge left within liquid crystal capacitors after a preceding image is shown. For solving such residual image phenomenon, U.S. Pat. No. 6,476,590 suggests that, upon powering off the LCD device, a timing controller generates a specific signal enabling a source driver to generate a pattern of data signal to the LCD device panel, so that the LCD device panel may display such specific image as a full black or full white image. Because a complexity of the hardware circuit is concerned, another improved method is developed.

### SUMMARY OF THE INVENTION

Accordingly, the present invention is directed to a method and a liquid crystal display for preventing residual images that substantially obviates one or more of the problems due to limitations and disadvantages of the prior art.

In one aspect of the present invention, a liquid crystal display device for preventing residual image comprises a liquid crystal panel comprising a plurality of pixel units for displaying an image, a detecting circuit for generating a power control signal in response to a power switching signal, and a source driver. The source driver comprises a processing unit, a plurality of first switch units, and a plurality of second switch units. The processing unit is used for providing a data signal. The plurality of first switch units electrically coupled to the processing unit, are used for conducting the data signal to the plurality of pixel units when the power switching signal is at a first state. The plurality of second switch units are used for electrically connected the plurality of pixel units when the power switching signal is at a second state.

In one embodiment of the present invention, the source driver further comprises a third switch unit electrically coupled to the constant supply terminal and one of the plurality of second switch units for conducting the predetermined voltage level to the plurality of pixel units when the power switching signal is at the second state.

In another embodiment of the present invention, the source driver further comprises a third switch unit electrically coupled to the constant supply terminal and one of the plurality of second switch units for conducting the predetermined voltage level to the plurality of pixel units when the power switching signal is at a third state.

In still another embodiment of the present invention, the liquid crystal display device comprises a power supply for generating a power supply signal equivalent to the power control signal, wherein the detecting circuit is used for generating the power switching signal in response to a transition of the power supply signal from a first voltage level to a second voltage level.

Another aspect of the present invention is directed to a method of preventing residual image phenomenon in a liquid crystal display device. The liquid crystal display device comprises a liquid crystal panel comprising a plurality of pixel units for displaying an image. The method comprises the steps of generating a power control signal in response to a power switching signal; conducting a data signal to the plurality of pixel units when the power switching signal is at a first state; and electrically connecting the plurality of pixel units when the power switching signal is at a second state.

In one embodiment of the present invention, the step of electrically connecting the plurality of pixel units when the power switching signal is at a second state comprises: conducting a predetermined voltage level to the plurality of pixel units when the power switching signal is at the second state.

In another embodiment of the present invention, the method of the present invention further comprises the step of conducting a predetermined voltage level to the plurality of pixel units when the power switching signal is at a third state.

In still another embodiment of the present invention, the liquid crystal display device further comprises a power supply for generating a power supply signal equivalent to the power control signal. The method further comprises the step of generating the power switching signal in response to a transition of the power supply signal from a first voltage level to a second voltage level.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a liquid crystal display according to the preferred embodiment of the present invention.

FIG. 2 is a block diagram of a processing unit of the source driver depicted in FIG. 1.

FIG. 3 is a timing diagram of the input data signal, a clock signal, an enabling signal, a control signal, and an output data signal of the source driver depicted in FIG. 2.

FIG. 4 is a schematic diagram of the source driver incorporating the timing controller and according to the first embodiment of the present invention

FIG. 4A shows a schematic diagram of the timing controller and the source driver in the moment of powering off in accordance with a first embodiment of the present invention.

FIG. 4B is a schematic diagram of the timing controller and the source driver in the moment of powering off in accordance with a second embodiment of the present invention.

FIG. 4C is a schematic diagram of the timing controller and the source driver in the moment of powering off in accordance with a third embodiment of the present invention.

FIG. 5 illustrates a timing diagram of power off signal upon powering on or powering off the LCD device.

FIG. 6 is timing diagram of an analog power supply signal AVDD, a digital power supply signal XVCC/YVCC, a power switching signal PW_OFF and a gate controlling signal XON.

FIG. 7 shows a timing diagram of the power supply signal, a power switching signal PW_OFF, and outputs Y1-Yn of the source driver according to the present invention.

FIG. 8 shows the timing controller and a source driver according to fourth embodiment of the present invention.

FIG. 8A is a schematic diagram of the timing controller and the source driver in the moment of powering off depicted in FIG. 8.

FIG. 8B is a schematic diagram of the timing controller and the source driver in the moment of powering off in accordance with a fifth embodiment of the present invention.

FIG. 8C is a schematic diagram of the timing controller and the source driver in the moment of powering off in accordance with a sixth embodiment of the present invention.

FIG. 9 shows a timing diagram of the power switching signal PW_OFF and related power signal upon powering on.

FIG. 10 shows a functional block diagram of the LCD device according to the seventh embodiment of the present invention.

FIG. 11 shows a functional block diagram of the LCD device according to the eighth embodiment of the present invention.

FIG. 12 shows a block diagram of the LCD device according to a ninth embodiment of the present invention.

FIG. 13 illustrates a flowchart of a method for driving the liquid crystal display illustrated in FIG. 1.

### DETAILED DESCRIPTION OF THE INVENTION

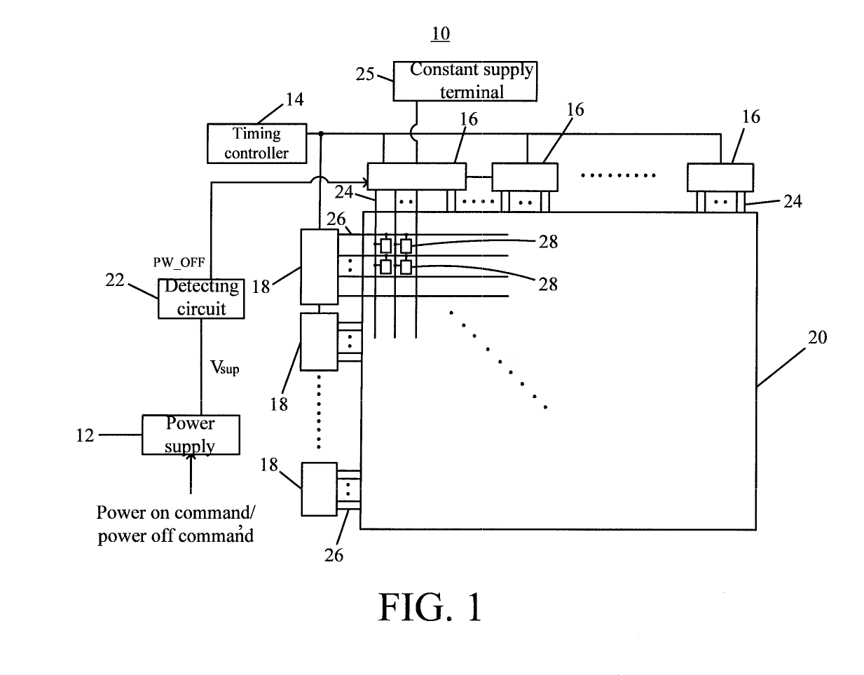

Referring to FIG. 1, illustrating a functional block diagram of a liquid crystal display (LCD) device 10 according to the preferred embodiment of the present invention, the liquid crystal display device 10 comprises a power supply 12, a timing controller 14, a plurality of source drivers 16, a plurality of gate drivers 18, a detecting circuit 22, and a liquid crystal panel 20. The liquid crystal panel 20 comprises a plurality of pixel units 28, each of which has a transistor and a liquid crystal capacitor. The power supply 12 is used for supplying operating voltages for driving the timing controller 14, the plurality of source drivers 16, the plurality of gate drivers 18, and the detecting circuit 22. For clarity, in FIG. 1, only connections between power supply 12 and detecting circuit 22 are shown, all other circuits are omitted. Upon receiving clock signal from the timing controller 14, the plurality of gate drivers 18 generate scan signal to the liquid crystal panel 20 via the scan lines 26. Meanwhile, the plurality of source drivers 16 delivers data signal to the liquid crystal panel 20 via the data lines 24, in response to the clock signal from the timing controller 14. As a result, the pixel units 28 show an image based on the data signal in response to the scan signal. The detecting circuit 22 may be integrated within the source driver 16.

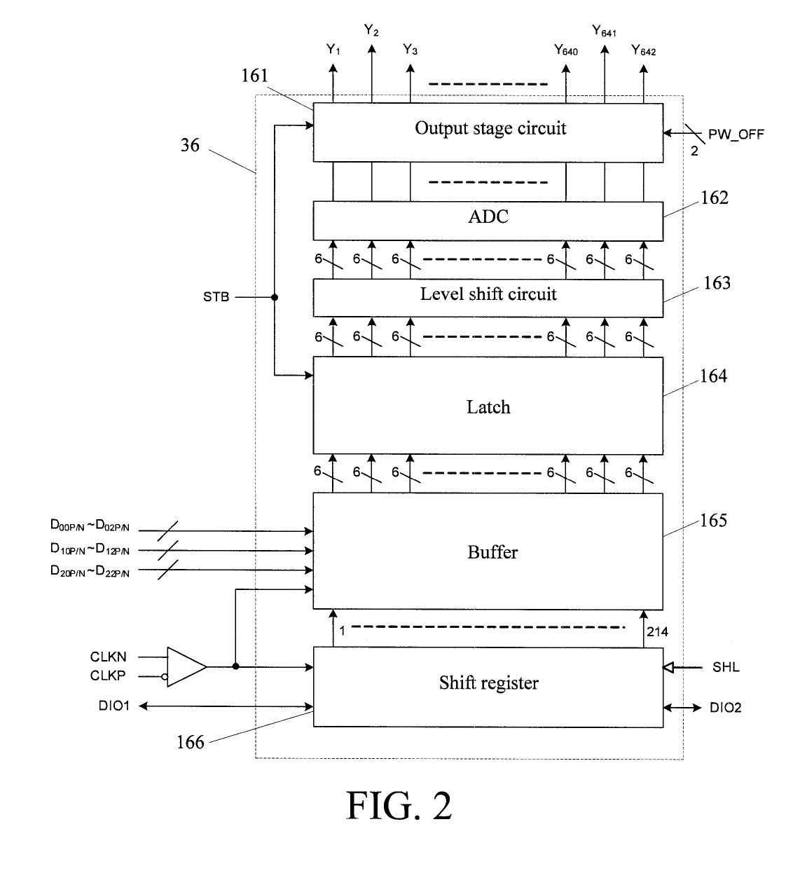

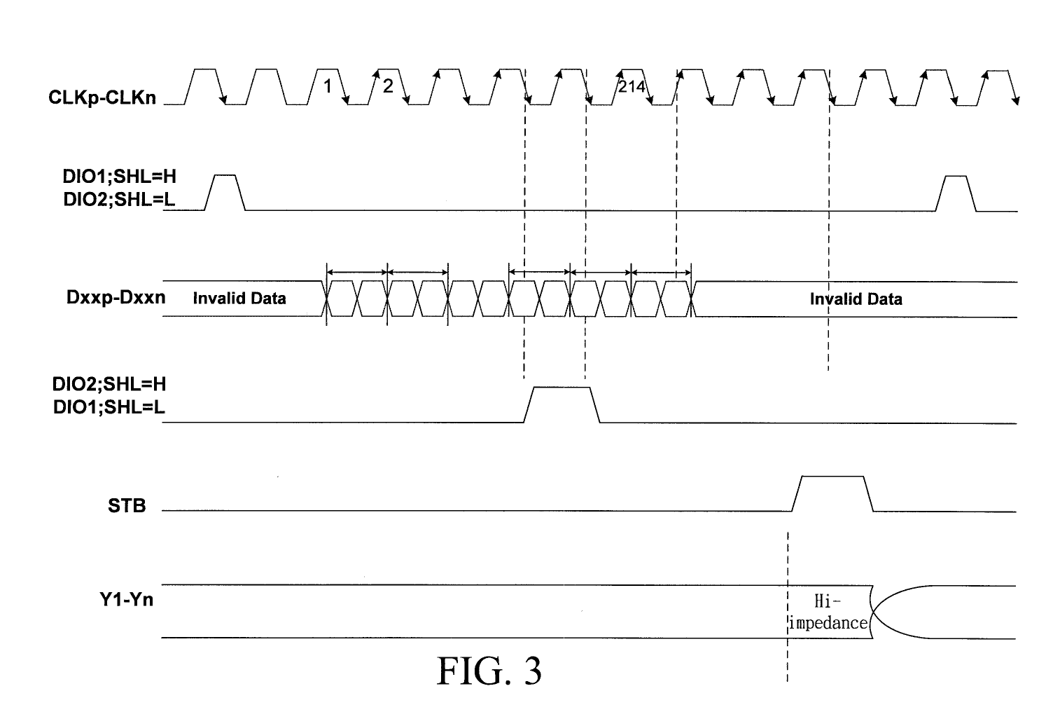

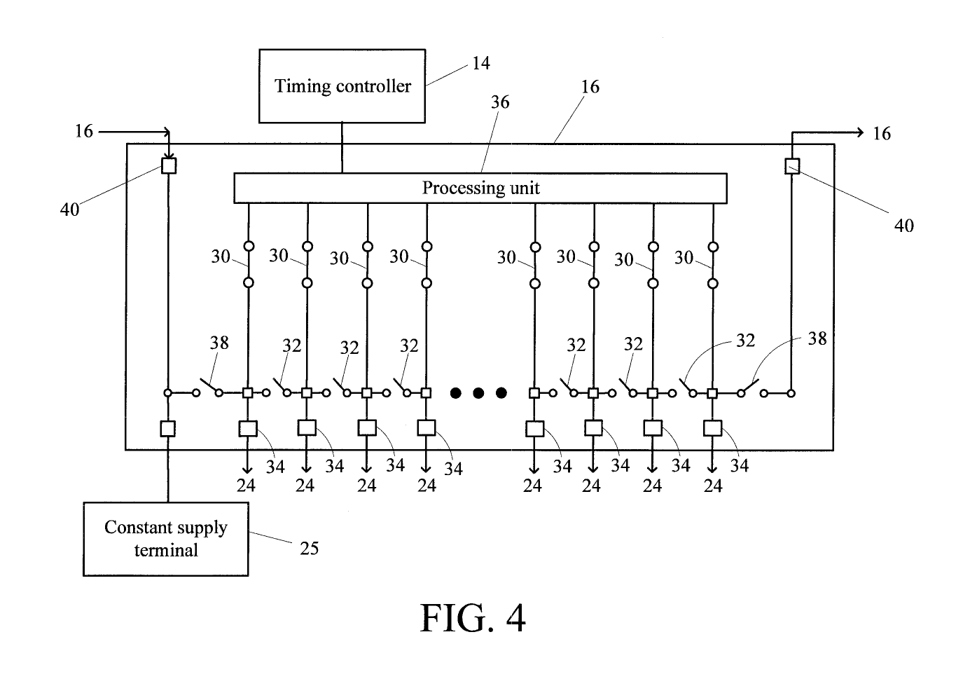

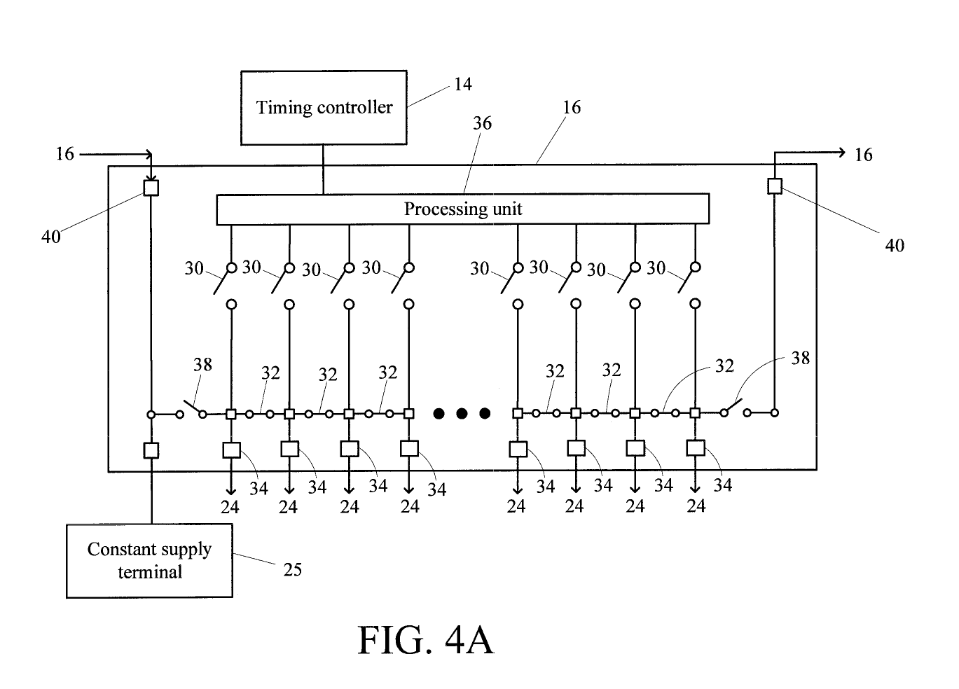

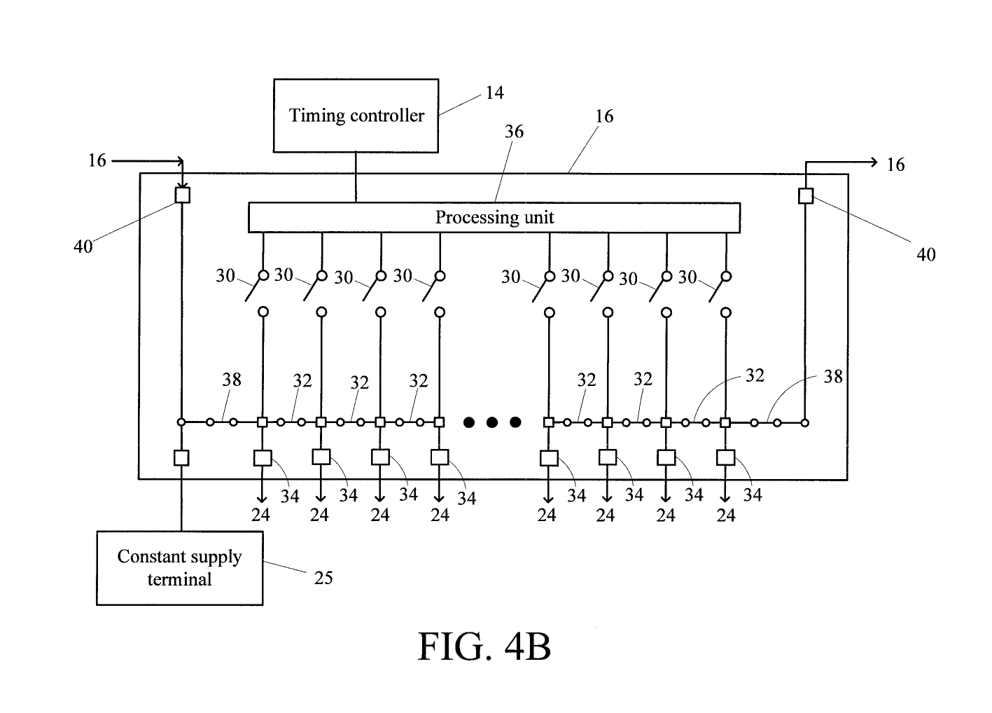

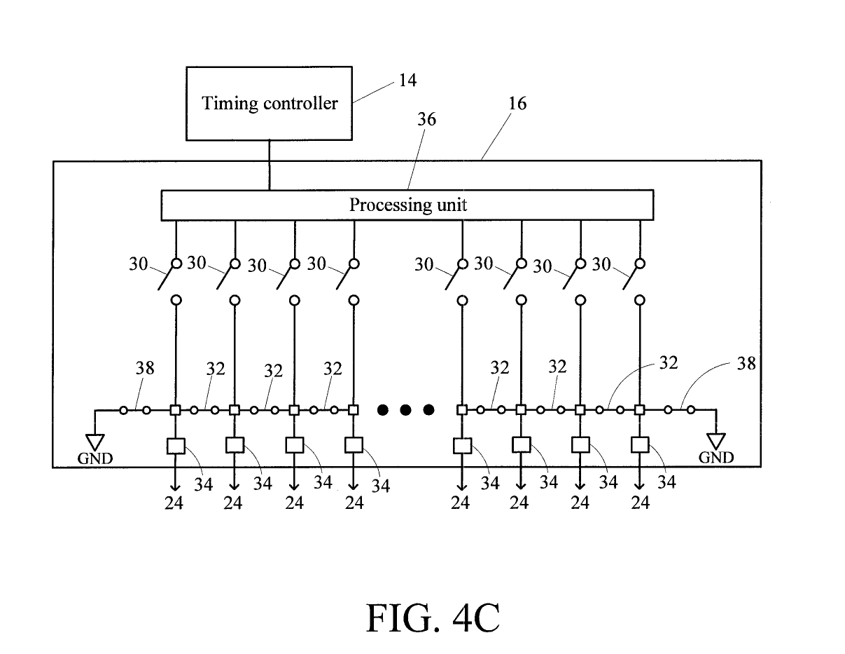

FIG. 2 is a functional block diagram of a processing unit 36 of the source driver 16 depicted in FIG. 1. FIG. 3 is a timing diagram of the input data signal, a clock signal, an enabling signal, a control signal, and an output data signal of the source driver 16 depicted in FIG. 2. FIG. 4 is a schematic diagram of the source driver incorporating the timing controller and according to the first embodiment of the present invention. As shown in FIG. 4, the source driver 16 comprises a plurality of first switch units 30, a plurality of switch units 32, a plurality of output pads 34, a plurality of switch units 38, a plurality of connecting ends 40, and a processing unit 36. Outputs Y1-Yn of the source driver 16 are delivered to the corresponding pixel units 28 by means of the output pads 34 and the data lines 24. Every two neighbor source drivers 16 are electrically connected via the connecting ends 40. As shown in FIG. 2, the processing unit 36 comprises an output stage circuit 161, a digital-to-analog converter (ADC) 162, a level shift circuit 163, a latch 164, a buffer 165, and a shift register 166. The timing controller 14 sends data signals D00P/N-D02P/N, D10P/N-D102P/N, D20P/N-D22P/N to the buffer 165 through a bus. The clock signal CLKP/N is fed to the shift register 166 and the buffer 165. When the shift register 166 enables to read data signal in response to enabling signal DIO1, the enabling signal DIO2 is then fed into the following stage source driver 16. The shift direction control signal SHL is used for controlling a shift direction. The control signal STB is fed to the latch 164 and the output stage circuit 161. While the control signal is at a rising edge, video data stream is delivered from the buffer 165 to the latch 164; alternatively, while the control signal is at a falling edge, the video data stream is fed to the pixel units 28 of the liquid crystal panel 20 via the output stage circuit 161. When the control signal STB is between the rising edge and the falling edge, output of the source driver 16 becomes high impedance. In addition, the detecting circuit 22 generates a power switching signal PW_OFF when detecting a transition of the power supply signal. The power switching signal PW_OFF is in the form of multiple bits, e.g. 2 bits is used as an example in this embodiment.

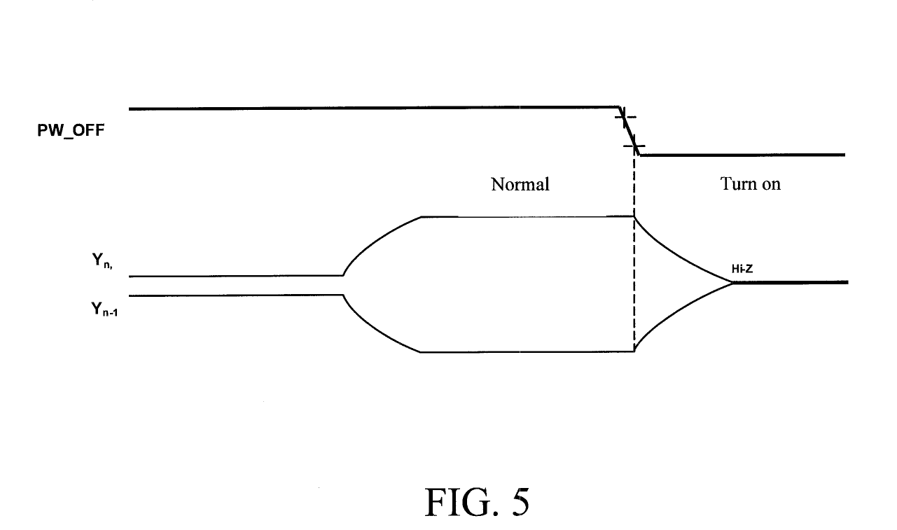

Referring to FIG. 4 in conjunction with FIG. 5, there is illustrated a timing diagram of power off signal upon powering on or powering off the LCD device 10. The power switching signal PW_OFF consists of four states: (H,H) (H,L) (L,H) (L,L). Moreover, the four states of the power switching signal PW_OFF determine on/off state of the switches 30, 32, and 38. When the LCD device 10 is under normal operation, the power switching signal PW_OFF is at first state (H,H). At this moment, the first switches 30 are turned on, but the second switches 32 and third switches 38 are turned off, as shown in FIG. 4. Meanwhile, the processing unit 36 sends the data signal to the plurality of output pads 34. Finally the data signal is sent to the corresponding pixel units 28 via the data lines 24.

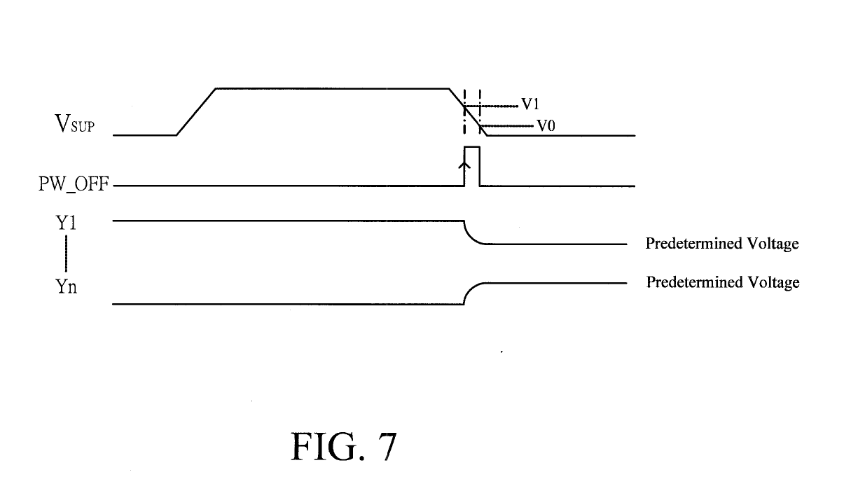

FIG. 4A is a schematic diagram of the timing controller and the source driver 16 in the moment of powering off in accordance with a first embodiment of the present invention, and FIG. 7 shows a timing diagram of the power supply signal, a power switching signal PW_OFF, and outputs Y1-Yn of the source driver 16 according to the present invention. Once the LCD device 10 receives a power off command, the power supply 12 lowers its power supply signal Vₛᵤₚ, and as long as the detecting circuit 22 detects the voltage level of the power supply signal Vₛᵤₚ is below V1, the power switching signal PW_OFF at a second state (H,L) is fed to the source driver 16. In this embodiment, the power supply signal Vₛᵤₚ may be a digital power supply signal or an analog power supply signal. Meanwhile, the first switch units 30 and the third switch units 38 are turned off, but the second switch units 32 are turned on. At this moment, the output pads 34 are electrically connected to each other. Accordingly, all of the pixel units 28 are applied with an identical voltage level, therefore the image is displayed with the same grey level.

Referring to FIG. 4B and FIG. 7, FIG. 4B is a schematic diagram of the timing controller and the source driver 16 in the moment of powering off in accordance with a second embodiment of the present invention. As long as the detecting circuit 22 detects the voltage level of the power supply signal Vₛᵤₚ is below V1, the power switching signal PW_OFF at a third state (L,L) is fed to the source driver 16. In this embodiment, the power supply signal Vₛᵤₚ may be a digital power supply signal or an analog power supply signal. Meanwhile, the first switch units 30 are turned off, but the second switch units 32 and the third switch units 38 are turned on. At this moment, the output pads 34 are electrically connected to the constant supply terminal 25. In other words, all of the pixel units 28 are applied with a predetermined voltage level, e.g. a common voltage or any appreciated reference voltage, supplied by the constant supply terminal 25. Accordingly, all of the pixel units 28 are applied an identical predetermined voltage level, and the image is evenly displayed with the same grey level. In this way, the residual image is avoided in the liquid crystal panel 20.

Referring to FIG. 4C and FIG. 7. FIG. 4C is a schematic diagram of the timing controller and the source driver 16 in the moment of powering off in accordance with a third embodiment of the present invention. As long as the detecting circuit 22 detects the voltage level of the power supply signal Vₛᵤₚ is below V1, the power switching signal PW_OFF at a four state (L,H) is fed to the source driver 16. In this embodiment, the power supply signal Vₛᵤₚ may be a digital power supply signal or an analog power supply signal. Meanwhile, the first switch units 30 are turned off, but the second switch units 32 and the third switch units 38 are turned on. At this moment, the output pads 34 are electrically connected to ground end GND. In other words, all of the pixel units 28 are applied a ground voltage supplied by the ground end GND. Accordingly, the image is evenly displayed with the same grey level. In this way, the residual image is avoided in the liquid crystal panel 20.

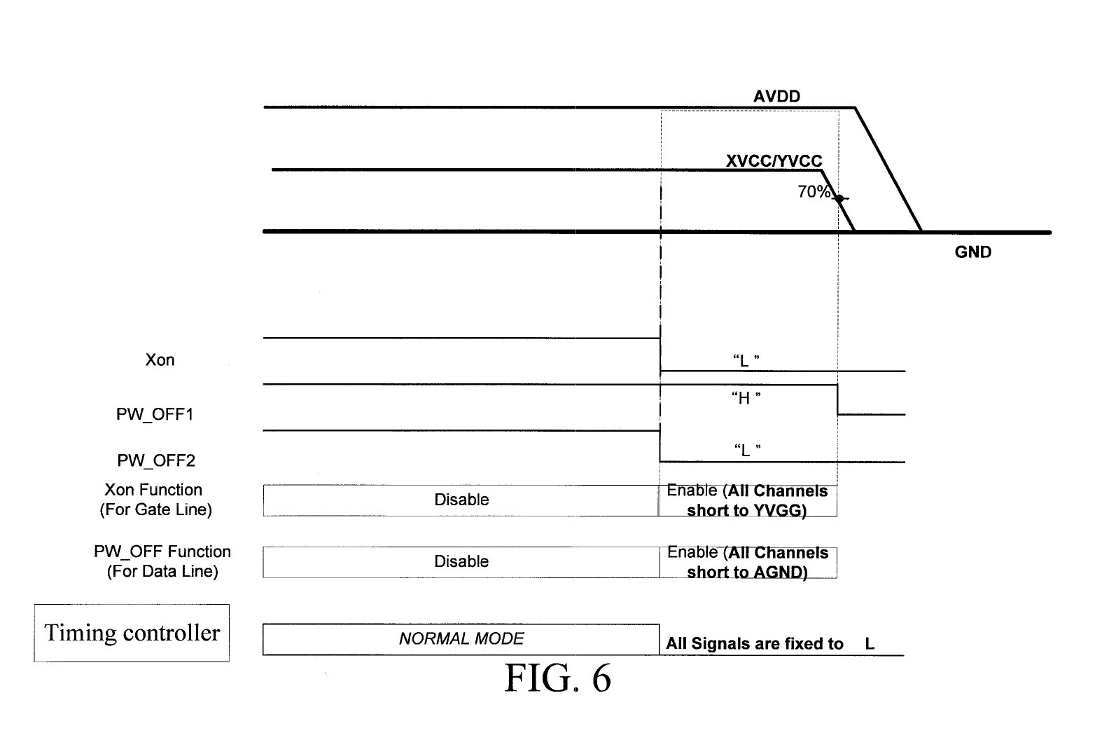

With reference to FIG. 6, FIG. 6 is timing diagram of an analog power supply signal AVDD, a digital power supply signal XVCC/YVCC, a power switching signal PW_OFF and a gate controlling signal XON. The detecting circuit 22 generates the power switching signal PW_OFF based on the power supply signal Vₛᵤₚ, and the source driver 16 enables the mechanism of preventing residual image in response to the states of the power switching signal PW_OFF. The power supply signal Vₛᵤₚ may be an analog power supply signal AVDD or a digital power supply signal XVCC/YVCC. All gate electrodes of transistors of the pixel units 28 turns on in response to a low logical level “L” of the gate controlling signal XON. In the mean time, all of the liquid crystal capacitors of the pixel units 28 of the liquid crystal panel 20 are charged, and all of the pixel units 28 are applied accordingly an identical predetermined voltage level. Consequently, the liquid crystal panel 20 shows an image with the same grey level.

FIG. 7 shows a timing diagram of power supply signal Vsup, power switching signal PW_OFF, and output Y1-Yn of the source driver 16 according to the present invention. It is noted that a pulse of the power off signal PW_OFF is generated by the detecting circuit 22 over the time period in which the power supply signal Vₛᵤₚ is from level V1 to level V0. And the switch units 30, 32, 38 are turned on based on the power switching signal PW_OFF.

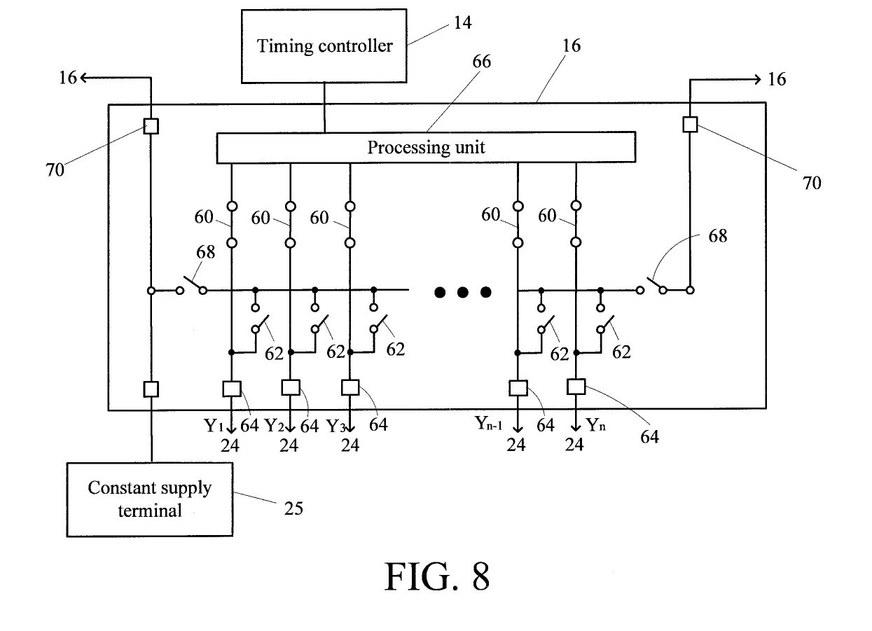

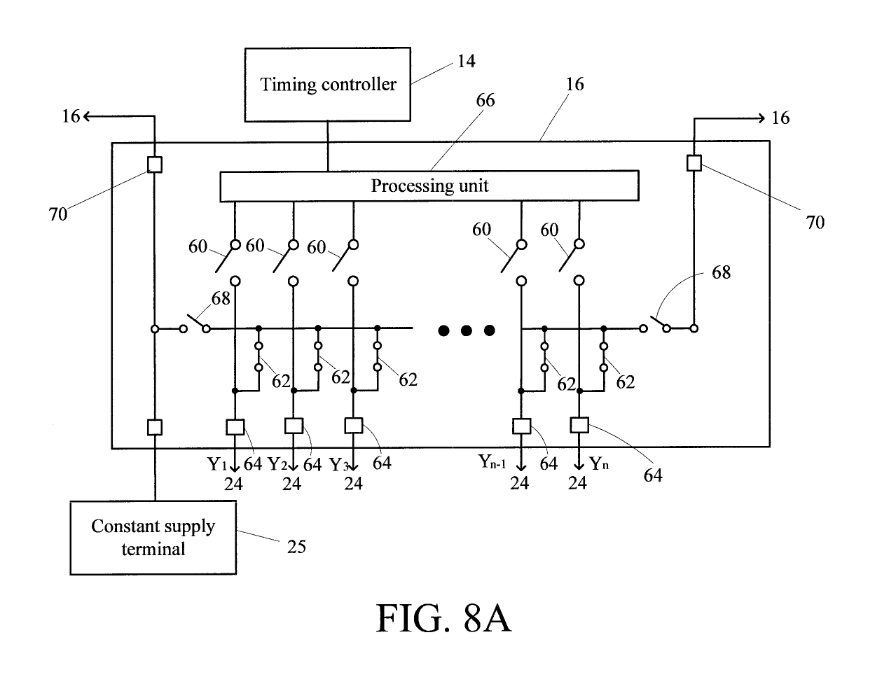

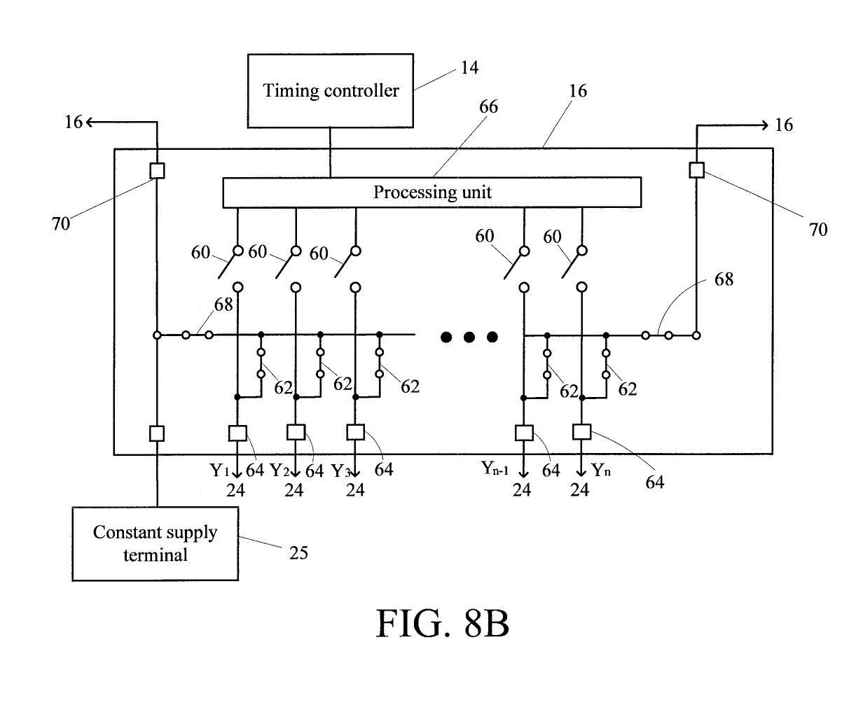

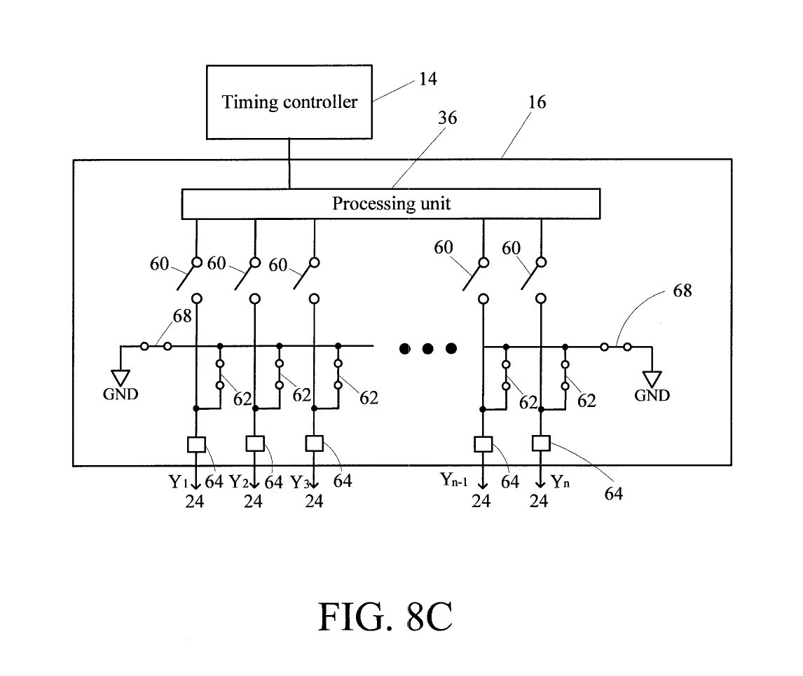

With reference to FIG. 8 showing the timing controller 14 and a source driver 16 according to a fourth embodiment of the present invention, the source driver 16 comprises a plurality of first switch units 60, a plurality of switch units 62, a plurality of output pads 64, a plurality of switch units 68, a plurality of connecting ends 70, and a processing unit 66. The processing unit 66 has the same function and comprises the same element as the processing unit 36 depicted in FIG. 2. Every two neighbor source drivers 16 are electrically connected via the connecting ends 70.

When the LCD device 10 is under normal operation, the power switching signal PW_OFF is at first state (H,H). At this moment, the first switches 60 are turned on, but the second switches 62 and third switches 68 are turned off. Meanwhile, the processing unit 66 sends the data signal to the plurality of output pads 64. Finally the data signal is sent to the corresponding pixel units 28 via the data lines 24.

FIG. 8A is a schematic diagram of the timing controller and the source driver 16 depicted in FIG. 8 in the moment of powering off. Once the LCD device 10 receives a power off command, the power supply 12 lowers its power supply signal Vₛᵤₚ, and as long as the detecting circuit 22 detects the voltage level of the power supply signal Vₛᵤₚ is below V1, the power switching signal PW_OFF at a second state (H,L) is fed to the source driver 16. In this embodiment, the power supply signal Vₛᵤₚ may be a digital power supply signal XVCC/YVCC or an analog power supply signal AVDD. Meanwhile, the first switch units 60 and the third switch units 68 are turned off, but the second switch units 62 are turned on. At this moment, the output pads 64 are electrically connected to each other. Accordingly, all of the pixel units 28 are electrically connected to each other and are applied an identical voltage level, therefore the image is displayed with the same grey level.

FIG. 8B is a schematic diagram of the timing controller and the source driver 16 in the moment of powering off in accordance with a fifth embodiment of the present invention. As long as the detecting circuit 22 detects the voltage level of the power supply signal Vₛᵤₚ is below V1, the power switching signal PW_OFF at a third state (L,L) is fed to the source driver 16. In this embodiment, the power supply signal Vₛᵤₚ may be a digital power supply signal XVCC/YVCC or an analog power supply signal AVDD. Meanwhile, the first switch units 60 are turned off, but the second switch units 62 and the third switch units 68 are turned on. At this moment, the output pads 64 are electrically connected to the constant supply terminal 25. In other words, all of the pixel units 28 are applied a predetermined voltage level, e.g. a common voltage or any appreciated reference voltage, supplied by the constant supply terminal 25. Accordingly, all of the pixel units 28 are applied an identical predetermined voltage level, and the image is evenly displayed with the same grey level. In this way, therefore, the residual image is avoided in the liquid crystal panel 20.

FIG. 8C is a schematic diagram of the timing controller and the source driver 16 in the moment of powering off in accordance with a sixth embodiment of the present invention. As long as the detecting circuit 22 detects the voltage level of the power supply signal Vₛᵤₚ is below V1, the power switching signal PW_OFF at a four state (L,H) is fed to the source driver 16. In this embodiment, the power supply signal Vₛᵤₚ may be a digital power supply signal XVCC/YVCC or an analog power supply signal AVDD. Meanwhile, the first switch units 60 are turned off, but the second switch units 62 and the third switch units 68 are turned on. At this moment, the output pads 34 are electrically connected to ground end GND. In other words, all of the pixel units 28 are applied ground voltage supplied by the ground end GND. Accordingly, the image is evenly displayed with the same grey level. In this way, therefore, the residual image is avoided in the liquid crystal panel 20.

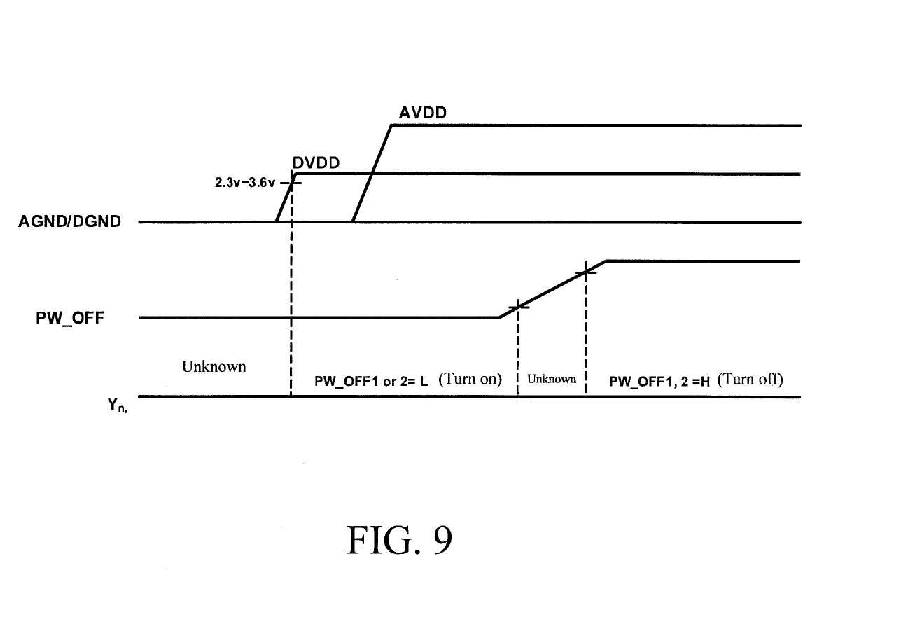

FIG. 9 shows a timing diagram of the power switching signal PW_OFF and related power signal upon powering on. It should be noted that, in another embodiment, the detecting circuit 22 generates a two-bit power switching signal PW_OFF when detecting a transition of the power supply signal, and outputs the two-bit power switching signal PW_OFF at second state (H,L), third state (L,H), or fourth state (L,L) to the source driver 16 upon powering on the LCD device 10. All of the source drivers 16 are capable of enabling the mechanism of preventing the residual image based on the states of the power switching signal PW_OFF described above.

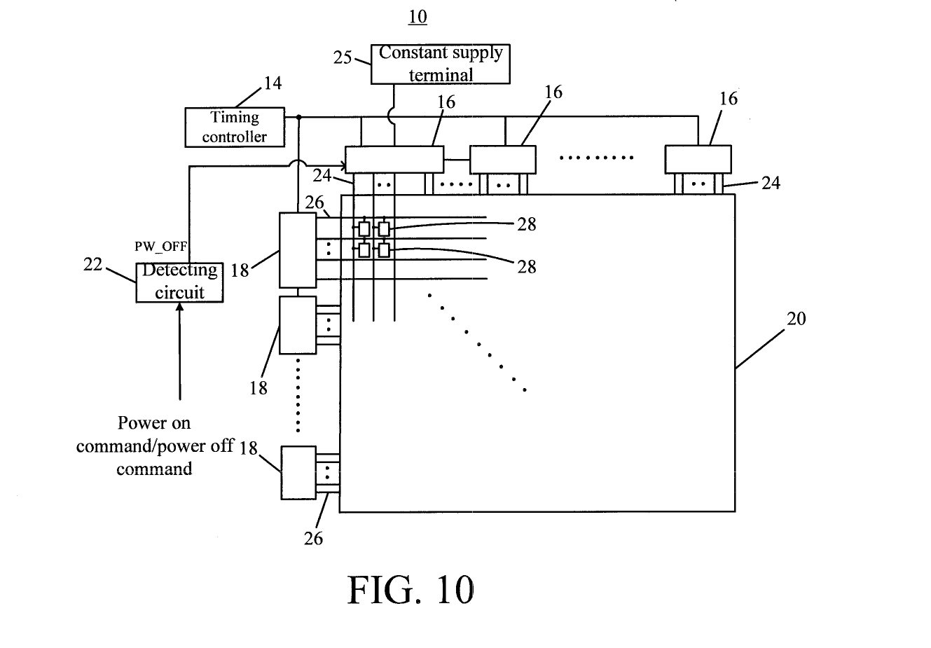

FIG. 10 shows a functional block diagram of the LCD device 10 according to the seventh embodiment of the present invention. Differing from the embodiment shown in FIG. 1, the detecting circuit 22 depicted in FIG. 10 generates the power switching signal PW_OFF depending on power-on command or power-off command from the user instead of the power supply signal Vₛᵤₚ. In other words, on receiving the power on command or power off command from the user, the detecting circuit 22 can directly output the power switching signal to control the on-off state of the switch units 60, 62, 68.

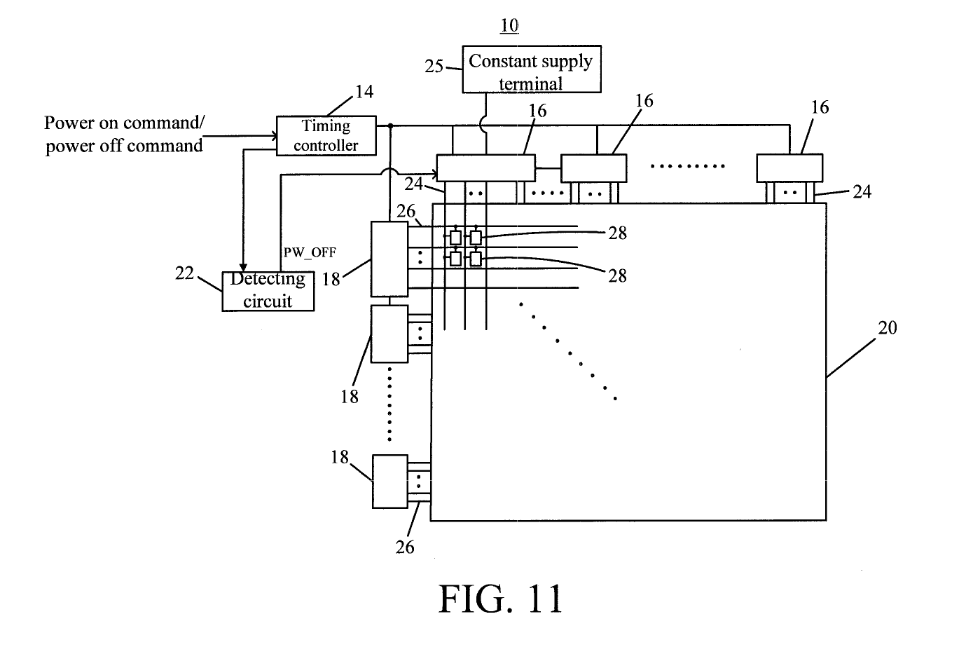

FIG. 11 shows a functional block diagram of the LCD device 10 according to an eighth embodiment of the present invention. Differing from embodiments shown in FIG. 1 and FIG. 10, the detecting circuit 22 depicted in FIG. 11 generates the power switching signal PW_OFF depending on output voltage of the timing controller 14. In other words, the timing controller 14 will output a power control signal to the detecting circuit 22 in response to a power on command or a power off command inputted from the user. Upon detecting a transition of the power control signal, the detecting circuit 22 can output the power switching signal to control the on-off state of the switch units.

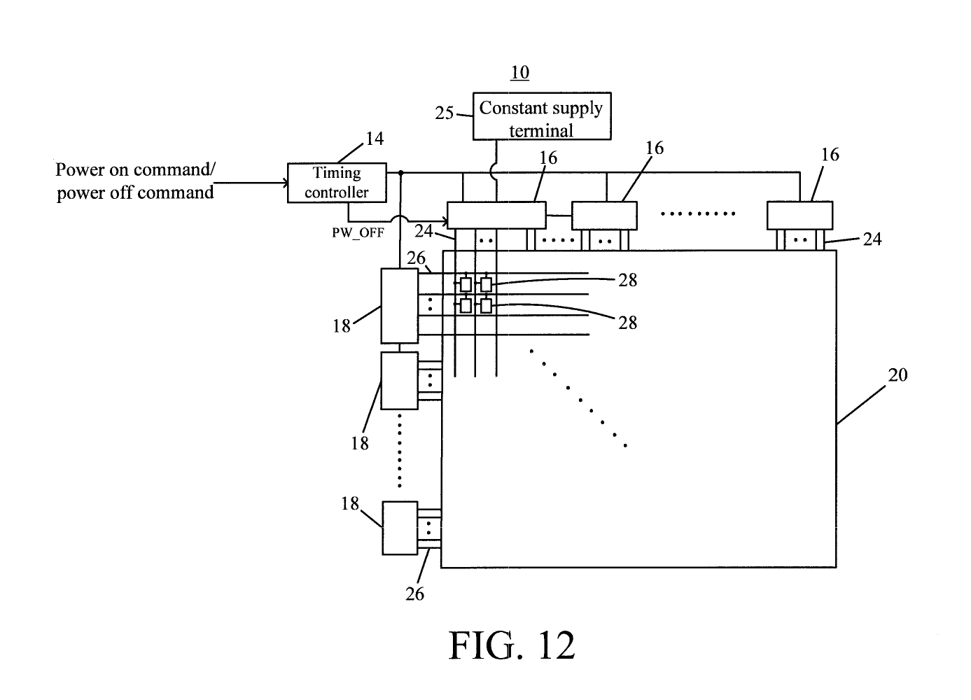

FIG. 12 shows a functional block diagram of the LCD device 10 according to a ninth embodiment of the present invention. Differing from the embodiment shown in FIG. 11, the timing controller 14 depicted in FIG. 12 generates the power switching signal PW_OFF in response to a power on command or a power off command inputted from the user. In other words, the timing controller 14 not only controls the source drivers 16 to deliver the data signal to the liquid crystal panel 20, but also to generate the power switching signal PW_OFF to control the on-off state of the switch units 60, 62, 68.

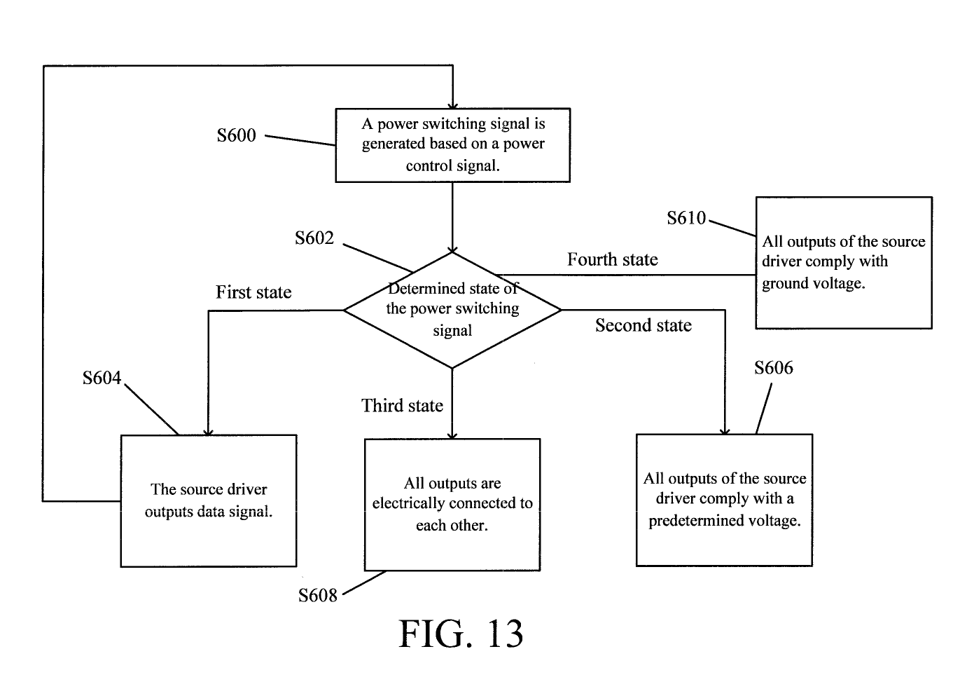

FIG. 13 illustrates a flowchart of a method for driving the liquid crystal display illustrated in FIG. 1, and the method will now be described as follows:
Step S600: A power switching signal is generated based on a power control signal. The power control signal may be a power on command or a power off command. The power control signal is allowed to be generated upon a transition of power supply signal.
Step S602: The state of the power switching signal is determined.
Step S604: When the power switching signal is at a first state, the source driver outputs data signal.
Step S606: When the power switching signal is at a second state, all outputs of the source driver comply with a predetermined voltage.
Step S608: When the power switching signal is at a third state, all outputs are electrically connected to each other.
Step S610: When the power switching signal is at a fourth state, all outputs of the source driver comply with ground voltage.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A liquid crystal display device for preventing residual image, comprising:
a liquid crystal panel comprising a plurality of pixel units, for displaying an image;
a detecting circuit for generating a power control signal in response to a power switching signal; and
a source driver, comprising:
a processing unit for providing a data signal;
a plurality of first switch units electrically coupled to the processing unit, for conducting the data signal to the plurality of pixel units when the power switching signal is at a first state; and
a plurality of second switch units for electrically connecting the plurality of pixel units when the power switching signal is at a second state.

2. The liquid crystal display device of claim 1, wherein the detecting circuit is integrated within the source driver.

3. The liquid crystal display device of claim 1, further comprising a constant supply terminal for supplying a predetermined voltage.

4. The liquid crystal display device of claim 3, wherein the source driver further comprises a third switch unit electrically coupled to the constant supply terminal and one of the plurality of second switch units, for conducting the predetermined voltage level to the plurality of pixel units when the power switching signal is at the second state.

5. The liquid crystal display device of claim 3, wherein the source driver further comprises a third switch unit electrically coupled to the constant supply terminal and one of the plurality of second switch units for conducting the predetermined voltage level to the plurality of pixel units when the power switching signal is at a third state.

6. The liquid crystal display device of claim 1, wherein each of the plurality of the second switch units is electrically coupled between two of the plurality of first switch units.

7. The liquid crystal display device of claim 1, wherein the processing unit comprises a shift register.

8. The liquid crystal display device of claim 1, wherein the power control signal is a power on command or a power off command.

9. The liquid crystal display device of claim 1, further comprising a timing controller for generating the power control signal.

10. The liquid crystal display device of claim 1, further comprising a power supply for generating a power supply signal equivalent to the power control signal, wherein the detecting circuit is used for generating the power switching signal in response to a transition of the power supply signal from a first voltage level to a second voltage level.

11. The liquid crystal display device of claim 10, wherein the first voltage level is higher than the second voltage level.

12. The liquid crystal display device of claim 10, wherein the first voltage level is smaller than the second voltage level.

13. A method of preventing residual image phenomenon in a liquid crystal display device, the liquid crystal display device comprising a liquid crystal panel having a plurality of pixel units for displaying an image, the method comprising:
generating a power control signal in response to a power switching signal;
conducting a data signal to the plurality of pixel units when the power switching signal is at a first state; and
electrically connecting the plurality of pixel units when the power switching signal is at a second state.

14. The method of claim 13, wherein the step of electrically connecting the plurality of pixel units when the power switching signal is at a second state comprises:
conducting a predetermined voltage level to the plurality of pixel units when the power switching signal is at the second state.

15. The method of claim 13, further comprising:
conducting a predetermined voltage level to the plurality of pixel units when the power switching signal is at a third state.

16. The method of claim 13, wherein the power control signal is a power on command or a power off command.

17. The method of claim 13, wherein the liquid crystal display device further comprises a power supply for generating a power supply signal equivalent to the power control signal, the method further comprises:
generating the power switching signal in response to a transition of the power supply signal from a first voltage level to a second voltage level.

18. The method of claim 17, wherein the first voltage level is higher than the second voltage level.

19. The method of claim 17, wherein the first voltage level is lower than the second voltage level.
